(19) United States
(12) Patent Application Publication
(10) Pub. No.: US 2005/0222333 A1
(43) Pub. Date: Oct. 6, 2005

(54) Aqueous electrically doped conductive polymers and polymeric acid colloids

(76) Inventor: Che-Hsiung Hsu, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/814,917

(22) Filed: Mar. 31, 2004

(51) Int. Cl. C08F 8/30

(52) U.S. Cl. 525/178

(57) ABSTRACT

Compositions, methods of making such compositions, are provided. Such compositions are aqueous dispersions including at least one doped conductive polymer and at least one colloid-forming polymeric acid, wherein the electrically doped conducting polymer is doped with at least one non-polymeric organic acid anion, and wherein the conductive polymer is selected from a polythiophene, a polypyrrole, a polyaniline, and combinations thereof. Electronic devices and other applications having at least one layer having at least one such composition are further provided.

### FIELD OF THE INVENTION

The invention relates to aqueous dispersions of one electrically doped conducting polymer and colloid-forming polymeric acid.

### BACKGROUND OF THE INVENTION

Electrically conducting polymers have been used in a variety of organic electronic devices, including in the development of electroluminescent (“EL”) devices for use in light emissive displays. With respect to EL devices, such as organic light emitting diodes (OLEDs) containing conducting polymers, such devices generally have the following configuration:
anode/buffer layer/EL material/cathode
The anode is typically any material that is transparent and has the ability to inject holes into the EL material, such as, for example, indium/tin oxide (ITO). The anode is optionally supported on a glass or plastic substrate. EL materials include fluorescent dyes, fluorescent and phosphorescent metal complexes, conjugated polymers, and mixtures thereof. The cathode is typically any material (such as, e.g., Ca or Ba) that has the ability to inject electrons into the EL material.

The buffer layer is typically an electrically conducting polymer and facilitates the injection of holes from the anode into the EL material layer. The buffer layer can also be called a hole-injection layer, a hole transport layer, or may be characterized as part of a bilayer anode. Typical conducting polymers employed as buffer layers include polyaniline and polydioxythiophenes such as poly(3,4-ethylenedioxythiophene) (PEDT). These materials can be prepared by polymerizing aniline or dioxythiophene monomers in aqueous solution in the presence of a water soluble polymeric acid, such as poly(styrenesulfonic acid) (PSSA), or poly(2-acrylamido-2-methyl-1-propanesulfonic acid) (“PAAMPSA”), as described in, for example, U.S. Pat. No. 5,300,575 and published PCT application WO 02/065484. A well known PEDT/PSS material is Baytron®-P, commercially available from H. C. Starck, GmbH (Leverkusen, Germany).

There is a need for improved conductive polymers with good processability and increased conductivity.

### SUMMARY OF THE INVENTION

New compositions, and methods of making such compositons, are provided comprising aqueous dispersions comprising at least one doped conductive polymer and at least one colloid-forming polymeric acid, wherein the doped conductive polymer is selected from a polythiophene, a polypyrrole, a polyaniline, and combinations thereof, and further wherein the electrically doped conducting polymer is doped with at least one non-polymeric organic acid anion.

In another embodiment, conductive or semiconductive layers made from the new composition are provided.

In another embodiment, buffer layers made from the new composition are provided.

In another embodiment, electronic devices comprising at least one layer made from the new composition are provided.

The foregoing general description and the following detailed description are exemplary and explanatory only and are not restrictive of the invention, as defined in the appended claims.

### BRIEF DESCRIPTION OF THE FIGURES

The invention is illustrated by way of example and not limited in the accompanying figures.

FIG. 1 illustrates a cross-sectional view of one electronic device that comprising at least one layer comprising at least one new composition. In this example, the layer is a buffer layer.

FIG. 2 illustrates a cross-sectional view of a thin film field effect transistor that comprises an electrode comprising at least one new composition.

### DETAILED DESCRIPTION OF THE INVENTION

Compositions, and methods of making such compositions are provided. The compositions are aqueous dispersions comprising at least one doped conductive polymer and at least one colloid-forming polymeric acid, wherein the electrically conducting polymer is doped with at least one non-polymeric organic acid anion, and wherein the doped conductive polymer is selected from a polythiophene, a polypyrrole, a polyaniline, and combinations thereof.

As used herein, the term “dispersion” refers to a continuous liquid medium containing a suspension of minute particles. The “continuous medium” comprises an aqueous liquid. As used herein, the term “aqueous” refers to a liquid that has a significant portion of water and in one embodiment it is at least about 40% by weight water. As used herein, the term “colloid” refers to the minute particles suspended in the continuous medium, said particles having a nanometer-scale particle size. As used herein, the term “colloid-forming” refers to substances that form minute particles when dispersed in aqueous solution, i.e., “colloid-forming” polymeric acids are not water-soluble. As used herein, the term “doped” refers to the formation of an ion pair wherein the negative charge on a dopant balances the positive charge on a conductive polymer.

The conductive polymers suitable for the new composition can be homopolymers, or they can be co-polymers of two or more respective monomers. The composition may further comprise one or more different conductive polymers doped with one or more different non-polymeric acid anions, and further one or more different colloid-forming polymeric acids.

Polythiophenes contemplated for use in the new composition comprise Formula I below: 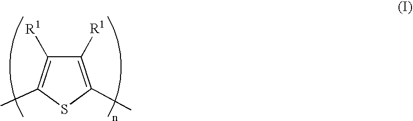
wherein:
   R¹ is independently selected so as to be the same or different at each occurrence and is selected from hydrogen, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, alcohol, benzyl, carboxylate, ether, ether carboxylate, amidosulfonate, ether sulfonate, and urethane; or both R¹ groups together may form an alkylene or alkenylene chain completing a 3, 4, 5, 6, or 7-membered aromatic or alicyclic ring, which ring may optionally include one or more divalent nitrogen, sulfur or oxygen atoms, and n is at least about 4.

As used herein, the term “alkyl” refers to a group derived from an aliphatic hydrocarbon and includes linear, branched and cyclic groups which may be unsubstituted or substituted. The term “heteroalkyl” is intended to mean an alkyl group, wherein one or more of the carbon atoms within the alkyl group has been replaced by another atom, such as nitrogen, oxygen, sulfur, and the like. The term “alkylene” refers to an alkyl group having two points of attachment.

As used herein, the term “alkenyl” refers to a group derived from an aliphatic hydrocarbon having at least one carbon-carbon double bond, and includes linear, branched and cyclic groups which may be unsubstituted or substituted. The term “heteroalkenyl” is intended to mean an alkenyl group, wherein one or more of the carbon atoms within the alkenyl group has been replaced by another atom, such as nitrogen, oxygen, sulfur, and the like. The term “alkenylene” refers to an alkenyl group having two points of attachment.

As used herein, the following terms for substituent groups refer to the formulae given below:

| | |
|---|---|
| “alcohol” | —R³—OH |
| “amidosulfonate” | —R³—C(O)N(R⁶)R⁴—SO₃Z |
| “benzyl” | —CH₂—C₆H₅ |
| “carboxylate” | —R³—C(O)O—Z |
| “ether” | —R³—O—R⁵ |
| “ether carboxylate” | —R³—O—R⁴—C(O)O—Z |
| “ether sulfonate” | —R³—O—R⁴—SO₃Z |
| “urethane” | —R³—O—C(O)—N(R⁶)₂ |

where all “R” groups are the same or different at each occurence and:
R³ is a single bond or an alkylene group
R⁴ is an alkylene group
R⁵ is an alkyl group
R⁶ is hydrogen or an alkyl group
Z is H, alkali metal, alkaline earth metal, N(R⁵)₄ or R⁵

where all “R” groups are the same or different at each occurrence and:
   R³ is a single bond or an alkylene group
   R⁴ is an alkylene group
   R⁵ is an alkyl group
   R⁶ is hydrogen or an alkyl group
   Z is H, alkali metal, alkaline earth metal, N(R⁵)₄ or R⁵
   Any of the above groups may further be unsubstituted or substituted, and any group may have F substituted for one or more hydrogens, including perfluorinated groups.

In one embodiment, in the polythiophene both R¹ together form —O—(CHY)ₘ—O—, where m is 2 or 3, and Y is the same or different at each occurrence and is selected from hydrogen, alkyl, alcohol, amidosulfonate, benzyl, carboxylate, ether, ether carboxylate, ether sulfonate, and urethane. In one embodiment, all Y are hydrogen. In one embodiment, the polythiophene is poly(3,4-ethylenedioxythiophene). In one embodiment, at least one Y group is not hydrogen. In one embodiment, at least one Y group is a substituent having F substituted for at least one hydrogen. In one embodiment, at least one Y group is perfluorinated.

Polypyrroles contemplated for use the new composition comprise Formula II below. 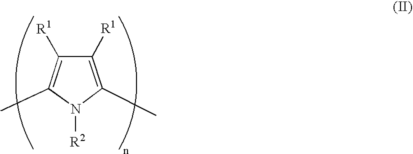
where in Formula II:
n is at least about 4;
R¹ is independently selected so as to be the same or different at each occurrence and is selected from hydrogen, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, alcohol, benzyl, carboxylate, ether, amidosulfonate, ether carboxylate, ether sulfonate, and urethane; or both R¹ groups together may form an alkylene or alkenylene chain completing a 3, 4, 5, 6, or 7-membered aromatic or alicyclic ring, which ring may optionally include one or more divalent nitrogen, sulfur or oxygen atoms; and
R² is independently selected so as to be the same or different at each occurrence and is selected from hydrogen, alkyl, alkenyl, aryl, alkanoyl, alkylthioalkyl, alkylaryl, arylalkyl, amino, epoxy, silane, siloxane, alcohol, benzyl, carboxylate, ether, ether carboxylate, ether sulfonate, and urethane.

In one embodiment, R¹ is the same or different at each occurrence and is independently selected from hydrogen, alkyl, alkenyl, alkoxy, cycloalkyl, cycloalkenyl, alcohol, benzyl, carboxylate, ether, amidosulfonate, ether carboxylate, ether sulfonate, urethane, epoxy, silane, siloxane, and alkyl substituted with one or more of sulfonic acid, carboxylic acid, acrylic acid, phosphoric acid, phosphonic acid, halogen, nitro, cyano, hydroxyl, epoxy, silane, or siloxane moieties.

In one embodiment, R² is selected from hydrogen, alkyl, and alkyl substituted with one or more of sulfonic acid, carboxylic acid, acrylic acid, phosphoric acid, phosphonic acid, halogen, cyano, hydroxyl, epoxy, silane, or siloxane moieties.

In one embodiment, the polypyrrole is unsubstituted and both R¹ and R² are hydrogen.

In one embodiment, both R¹ together form a 6- or 7-membered alicyclic ring, which is further substituted with a group selected from alkyl, heteroalkyl, alcohol, benzyl, carboxylate, ether, ether carboxylate, ether sulfonate, and urethane. These groups can improve the solubility of the monomer and the resulting polymer. In one embodiment, both R¹ together form a 6- or 7-membered alicyclic ring, which is further substituted with an alkyl group. In one embodiment, both R¹ together form a 6- or 7-membered alicyclic ring, which is further substituted with an alkyl group having at least 1 carbon atom.

In one embodiment, both R¹ together form —O—(CHY)ₘ—O—, where m is 2 or 3, and Y is the same or different at each occurrence and is selected from hydrogen, alkyl, alcohol, benzyl, carboxylate, amidosulfonate, ether, ether carboxylate, ether sulfonate, and urethane. In one embodiment, at least one Y group is not hydrogen. In one embodiment, at least one Y group is a substituent having F substituted for at least one hydrogen. In one embodiment, at least one Y group is perfluorinated.

Polyanilines contemplated for use in the new composition comprise Formula III or Formula IV below. 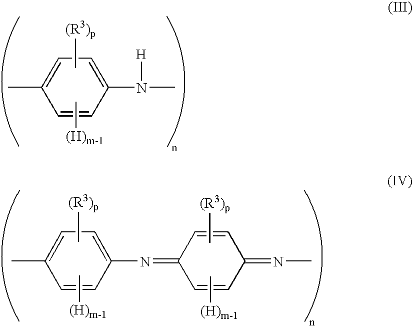
wherein:
n is at least about 4;
p is an integer from 0 to 4;
m is an integer from 1 to 5, with the proviso that p+m=5; and
R³ is independently selected so as to be the same or different at each occurrence and is selected from alkyl, alkenyl, alkoxy, cycloalkyl, cycloalkenyl, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen, cyano, or alkyl substituted with one or more of sulfonic acid, carboxylic acid, halo, nitro, cyano or epoxy moieties; or any two R³ groups together may form an alkylene or alkenylene chain completing a 3, 4, 5, 6, or 7-membered aromatic or alicyclic ring, which ring may optionally include one or more divalent nitrogen, sulfur or oxygen atoms.
In one embodiment, the polyaniline is unsubstituted and p=0.

Non-polymeric organic acid anions contemplated for use in the new compositions are derived from acids which are water soluble or dispersible. The charge of the anion balances the positive charge on the conductive polymer. In the case of polyaniline, the neutral polymer can be doped with the organic acid, thereby protonating at least some of the nitrogens to form a positively charged conductive polymer. As above, the charge is balanced by the negative charge of the acid anion. Examples of suitable acids include, but are not limited to, acetic acid, p-toluenesulfonic acid, camphorsulfonic acid, p-dodecylbenzenesulfonic acid, methanesulfonic acid, trifluoromethanesulfonic acid, and the like. The corresponding acid anions are acetate, p-toluenesulfonate, camphorsulfonate, p-dodecylbenzenesulfonate, methanesulfonate, and trifluoromethanesulfonate. Mixtures of acid anions can be used.

Colloid-forming polymeric acids contemplated for use in the new compositions are insoluble in water, and form colloids when dispersed into an aqueous medium. The polymeric acids typically have a molecular weight in the range of about 10,000 to about 4,000,000.

In one embodiment, the polymeric acids have a molecular weight of about 100,000 to about 2,000,000. Polymeric acid colloid particle size typically ranges from 2 nanometers (nm) to about 140 nm. In one embodiment, the colloids have a particle size of 2 nm to about 30 nm.

Any polymeric acid that is colloid-forming when dispersed in water is suitable for use to make the new compositions. In one embodiment, the colloid-forming polymeric acid comprises at least one polymeric acid selected form polymer sulfonic acid, polymeric phosphoric acids, polymeric phosphonic acids, polymeric carboxylic acids, and polymeric acrylic acids, and mixtures thereof. In another embodiment, the polymeric sulfonic acid is fluorinated. In still another embodiment, the colloid-forming polymeric sulfonic acid is perfluorinated. In yet another embodiment, the colloid-forming polymeric sulfonic acid comprises a perfluoroalkylenesulfonic acid.

In still another embodiment, the colloid-forming polymeric acid comprises a highly-fluorinated sulfonic acid polymer (“FSA polymer”). “Highly fluorinated” means that at least about 50% of the total number of halogen and hydrogen atoms in the polymer are fluorine atoms, an in one embodiment at least about 75%, and in another embodiment at least about 90%. In one embodiment, the polymer is perfluorinated. The term “sulfonate functional group” refers to either to sulfonic acid groups or salts of sulfonic acid groups, and in one embodiment alkali metal or ammonium salts. The functional group is represented by the formula —SO₃X where X is a cation, also known as a “counterion”. X may be H, Li, Na, K or N(R₁)(R₂)(R₃)(R₄), and R₁, R₂, R₃, and R₄ are the same or different and are and in one embodiment H, CH₃ or C₂H₅. In another embodiment, X is H, in which case the polymer is said to be in the “acid form”. X may also be multivalent, as represented by such ions as Ca⁺⁺, and Al⁺⁺⁺. It is clear to the skilled artisan that in the case of multivalent counterions, represented generally as Mⁿ⁺, the number of sulfonate functional groups per counterion will be equal to the valence “n”.

In one embodiment, the FSA polymer comprises a polymer backbone with recurring side chains attached to the backbone, the side chains carrying cation exchange groups. Polymers include homopolymers or copolymers of two or more monomers. Copolymers are typically formed from a nonfunctional monomer and a second monomer carrying the cation exchange group or its precursor, e.g., a sulfonyl fluoride group (—SO₂F), which can be subsequently hydrolyzed to a sulfonate functional group. For example, copolymers of a first fluorinated vinyl monomer together with a second fluorinated vinyl monomer having a sulfonyl fluoride group (—SO₂F) can be used. Possible first monomers include tetrafluoroethylene (TFE), hexafluoropropylene, vinyl fluoride, vinylidine fluoride, trifluoroethylene, chlorotrifluoroethylene, perfluoro(alkyl vinyl ether), and combinations thereof. TFE is a preferred first monomer.

In other embodiments, one other monomer includes fluorinated vinyl ethers with sulfonate functional groups or precursor groups which can provide the desired side chain in the polymer. Additional monomers, including ethylene, propylene, and R—CH═CH₂ where R is a perfluorinated alkyl group of 1 to 10 carbon atoms, can be incorporated into these polymers if desired. The polymers may be of the type referred to herein as random copolymers, that is copolymers made by polymerization in which the relative concentrations of the co-monomers are kept as constant as possible, so that the distribution of the monomer units along the polymer chain is in accordance with their relative concentrations and relative reactivities. Less random copolymers, made by varying relative concentrations of monomers in the course of the polymerization, may also be used. Polymers of the type called block copolymers, such as that disclosed in European Patent Application No. 1 026 152 A1, may also be used.

In one embodiment, FSA polymers for use in the new composition include a highly fluorinated, and in one embodiment perfluorinated, carbon backbone and side chains represented by the formula
—(O—CF₂CFR_{f})ₐ—O—CF₂CFR′_{f}SO₃X
wherein Rf and R′f are independently selected from F, Cl or a perfluorinated alkyl group having 1 to 10 carbon atoms, a=0, 1 or 2, and X is H, Li, Na, K or N(R1)(R2)(R3)(R4) and R1, R2, R3, and R4 are the same or different and are and in one embodiment H, CH₃ or C₂H₅. In another embodiment X is H. As stated above, X may also be multivalent.

In one embodiment, the FSA polymers include, for example, polymers disclosed in U.S. Pat. No. 3,282,875 and in U.S. Pat. Nos. 4,358,545 and 4,940,525. An example of preferred FSA polymer comprises a perfluorocarbon backbone and the side chain represented by the formula
—O—CF₂CF(CF₃)—O—CF₂CF₂SO₃X
where X is as defined above. FSA polymers of this type are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanged as necessary to convert them to the desired ionic form. An example of a polymer of the type disclosed in U.S. Pat. Nos. 4,358,545 and 4,940,525 has the side chain —O—CF₂CF₂SO₃X, wherein X is as defined above. This polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and further ion exchange as necessary.

In one embodiment, the FSA polymers for use in the new composition typically have an ion exchange ratio of less than about 33. In this application, “ion exchange ratio” or “IXR” is defined as number of carbon atoms in the polymer backbone in relation to the cation exchange groups. Within the range of less than about 33, IXR can be varied as desired for the particular application. In one embodiment, the IXR is about 3 to about 33, and in another embodiment about 8 to about 23.

The cation exchange capacity of a polymer is often expressed in terms of equivalent weight (EW). For the purposes of this application, equivalent weight (EW) is defined to be the weight of the polymer in acid form required to neutralize one equivalent of sodium hydroxide. In the case of a sulfonate polymer where the polymer has a perfluorocarbon backbone and the side chain is —O—CF₂—CF(CF₃)—O—CF₂—CF₂—SO₃H (or a salt thereof, the equivalent weight range which corresponds to an IXR of about 8 to about 23 is about 750 EW to about 1500 EW. IXR for this polymer can be related to equivalent weight using the formula: 50 IXR+344=EW. While the same IXR range is used for sulfonate polymers disclosed in U.S. Pat. Nos. 4,358,545 and 4,940,525, e.g., the polymer having the side chain —O—CF₂CF₂SO₃H (or a salt thereof, the equivalent weight is somewhat lower because of the lower molecular weight of the monomer unit containing a cation exchange group. For the preferred IXR range of about 8 to about 23, the corresponding equivalent weight range is about 575 EW to about 1325 EW. IXR for this polymer can be related to equivalent weight using the formula: 50 IXR+178=EW.

The synthesis of FSA polymers is well known. The FSA polymers can be prepared as colloidal aqueous dispersions. They may also be in the form of dispersions in other media, examples of which include, but are not limited to, alcohol, water-soluble ethers, such as tetrahydrofuran, mixtures of water-soluble ethers, and combinations thereof. In making the new compositions, the polymer can be used in acid form. In one embodiment, co-dispersing liquid of the aqueous FSA dispersions is optionally removed prior to or after combination with the conductive polymers. U.S. Pat. Nos. 4,433,082, 6,150,426 and WO 03/006537 disclose methods for making of aqueous dispersions. After the dispersion is made, the concentration and the dispersing liquid composition can be adjusted by methods known in the art.

In one embodiment, aqueous dispersions of the colloid-forming polymeric acids, including FSA polymers, have particle sizes as small as possible and an EW as small as possible, so long as a stable colloid is formed.

Aqueous dispersions of FSA polymer are available commercially as Nafion® dispersions, from E. I. du Pont de Nemours and Company (Wilmington, Del.).

Dispersions of electrically conductive polymers generally have a fairly low pH due to the presence of acids in the oxidative polymerization process. For example, aqueous poly(ethylenedioxythiophene) (“PEDT”) dispersions, Baytron®-P VP Al 4083 and CH8000, from H. C. Starck, GmbH, Leverkusen, Germany have a pH below 2. It is frequently desirable to have aqueous dispersions of conductive polymers with a higher pH, as the acidity can be corrosive. With Baytron-P, adjusting the pH to higher levels can have a deleterious effect on the electrical properties of the conductive polymer and their functional effectiveness as a buffer layer in OLEDs. In new compositions comprising aqueous dispersions of at least one electrically conducting polymer doped with at least one non-polymeric acid anion, and combined with nanoparticles of colloid-forming polymeric acids, it has been found that the pH can be adjusted without sacrificing electrical properties. The pH can be adjusted using known techniques, for example, ion exchange or by titration with an aqueous basic solution. Stable dispersions of conductive polymers doped with non-polymeric acid anions, and combined with colloid-forming polymeric acids can be formed with a pH adjusted from 1 to 8. Adjusting the pH to higher, more neutral values, does not deleteriously affect the electrical properties and device performance of the conductive polymers in the new composition, and in most cases improves those properties.

In one embodiment, the new composition is made by first forming the conductive polymer doped with non-polymeric organic acid anion, and then combining this with the colloid-forming polymeric acid. Aqueous solutions of polypyrrole doped with a non-polymeric organic acid anion are available from Sigma-Aldrich (St. Louis, Mo.). Polymerization of thiophene monomers has been extensively described as in, for example, U.S. Pat. No. 5,300,575. Polymerization of aniline monomers has also been extensively described as in, for example, U.S. Pat. No. 5,798,170. The materials can be blended using sonication or microfluidization to ensure mixing of the components.

In one embodiment, the new composition further comprises a co-dispersing liquid. As used herein, the term “co-dispersing liquid” refers to a substance which is liquid at room temperature and is miscible with water. As used herein, the term “miscible” means that the co-dispersing liquid is capable of being mixed with water (at concentrations set forth herein for each particular co-dispersing liquid) to form a substantially homogeneous solution.

Co-dispersing liquids contemplated for use in the new composition are generally polar, water-miscible organic liquids. Examples of suitable types of co-dispersing liquids include, but are not limited to, ethers, cyclic ethers, alcohols, alcohol ethers, ketones, nitriles, sulfides, sulfoxides, amides, amines, carboxylic acids, and the like, as well as combinations of any two or more thereof.

In one embodiment, the co-dispersing liquid comprises a liquid selected from, n-propanol, isopropanol, methanol, butanol, 1-methoxy-2-propanol, dimethylacetamide, n-methyl pryrozole, 1,4-dioxane, tetrahydrofuran, tetrahydropyran, 4 methyl-1,3-dioxane, 4-phenyl-1,3-dioxane, 1,3-dioxolane, 2-methyl-1,3-dioxolane, 1,3-dioxane, 2,5-dimethoxytetrahydrofuran, 2,5-dimethoxy-2,5-dihydrofuran, 1-methylpyrrolindine, 1-methyl-2-pyrrolidinone, dimethylsulfoxide, and combinations of any two or more thereof.

In one embodiment, the as-synthesized aqueous dispersion is contacted with at least one ion exchange resin under conditions suitable to remove decomposed species, side reaction products, unreacted monomers, and ionic impurities, and to adjust pH. The as-synthesized aqueous dispersion can be contacted with at least one ion exchange resin before or after the addition of a co-dispersing liquid. In one embodiment, the as-synthesized aqueous dispersion is contacted with a first ion exchange resin and a second ion exchange resin.

In another embodiment, the first ion exchange resin is an acidic, cation exchange resin, such as a sulfonic acid cation exchange resin set forth above, and the second ion exchange resin is a basic, anion exchange resin, such as a tertiary amine or a quaternary exchange resin.

Ion exchange is a reversible chemical reaction wherein an ion in a fluid medium (such as an aqueous dispersion) is exchanged for a similarly charged ion attached to an immobile solid particle that is insoluble in the fluid medium. The term “ion exchange resin” is used herein to refer to all such substances. The resin is rendered insoluble due to the crosslinked nature of the polymeric support to which the ion exchanging groups are attached. Ion exchange resins are classified as acidic, cation exchangers, which have positively charged mobile ions available for exchange, and basic, anion exchangers, whose exchangeable ions are negatively charged.

Both acidic, cation exchange resins and basic, anion exchange resins are contemplated for use in the new process. In one embodiment, the acidic, cation exchange resin is an organic acid, cation exchange resin, such as a sulfonic acid cation exchange resin. Sulfonic acid cation exchange resins contemplated for use in the new composition include, for example, sulfonated styrene-divinylbenzene copolymers, sulfonated crosslinked styrene polymers, phenol-formaldehyde-sulfonic acid resins, benzene-formaldehyde-sulfonic acid resins, and mixtures thereof. In another embodiment, the acidic, cation exchange resin is an organic acid, cation exchange resin, such as carboxylic acid, acrylic or phosphoric acid cation exchange resin. In addition, mixtures of different cation exchange resins can be used. In many cases, the basic ion exchange resin can be used to adjust the pH to the desired level. In some cases, the pH can be further adjusted with an aqueous basic solution such as a solution of sodium hydroxide, ammonium hydroxide, or the like.

In another embodiment, the basic, anionic exchange resin is a tertiary amine anion exchange resin. Tertiary amine anion exchange resins contemplated for use in the new compositions include, for example, tertiary-aminated styrene-divinylbenzene copolymers, tertiary-aminated crosslinked styrene polymers, tertiary-aminated phenol-formaldehyde resins, tertiary-aminated benzene-formaldehyde resins, and mixtures thereof. In a further embodiment, the basic, anionic exchange resin is a quaternary amine anion exchange resin, or mixtures of these and other exchange resins.

The first and second ion exchange resins may contact the as-synthesized aqueous dispersion either simultaneously, or consecutively. For example, in one embodiment both resins are added simultaneously to an as-synthesized aqueous dispersion, and allowed to remain in contact with the dispersion for at least about 1 hour, e.g., about 2 hours to about 20 hours. The ion exchange resins can then be removed from the dispersion by filtration. The size of the filter is chosen so that the relatively large ion exchange resin particles will be removed while the smaller dispersion particles will pass through. The basic, anion exchange and/or acidic, cation exchange resins renders the acidic sites more basic, resulting in increased pH of the dispersion. In general, at least 1 gram of ion exchange is used per about 1 gram of composition solids. In other embodiments, the use of the ion exchange resin is used in a ratio of up to about 5 grams of ion exchange resin to composition solids, and depends on the pH that is to be achieved. In one embodiment, about one gram of Lewatit® MP62 WS, a weakly basic anion exchange resin from Bayer GmbH, and about one gram of Lewatit® MonoPlus S100, a strongly acidic, sodium cation exchange resin from Bayer, GmbH, are used per gram of the new composition.

The new compositions can have a wide range of pH, which can be adjusted to typically be between about 1 to about 8, and generally have a pH of about 3-4. It is frequently desirable to have a higher pH, as the acidity can be corrosive. It has been found that the pH can be adjusted using known techniques, for example, ion exchange or by titration with an aqueous basic solution.

In another embodiment, more conductive dispersions are formed by the addition of highly conductive additives to the aqueous dispersions of conductive polymer, non-polymeric acid anion, and the colloid-forming polymeric acid. In one embodiment, new compositions with relatively high pH can be formed, and further comprise the conductive additives, especially metal additives, which are not attacked by the acid in the dispersion.

In one embodiment, the new composition further comprises at least one conductive additive at a weight percentage sufficient to reach the percolation threshold. Examples of suitable conductive additives include, but are not limited to conductive polymers, metal particles and nanoparticles, metal nanowires, carbon nanotubes, carbon nanopoarticles, graphite fibers or particles, carbon particles, and combinations thereof. A dispersing agent may be included to faciltate dispersing of the conductive additives.

In one embodiment, the new compositions are deposited to form electrically conductive or semiconductive layers which are used alone, or in combination with other electroactive materials, as electrodes, electroactive elements, photoactive elements, or bioactive elements. As used herein, the terms “electroactive element”, “photoactive element” and “bioactive element” refer to elements which exhibit the named activity in response to a stimulus, such as an electromagnetic field, an electrical potential, solar energy radiation, and a biostimulation field.

In one embodiment, the new compositions are deposited to form buffer layers in an electronic device. The term “buffer layer” as used herein, is intended to mean an electrically conductive or semiconductive layer which can be used between an anode and an active organic material. A buffer layer is believed to accomplish one or more function in an organic electronic device, including, but not limited to planarization of the underlying layer, hole transport, hole injection, scavenging of impurities, such as oxygen and metal ions, among other aspects to facilitate or to improve the performance of an organic electronic device.

The term “layer” or “film” refers to a coating covering a desired area. The area can be as large as an entire device or as small as a specific functional area such as the actual visual display, or as small as a single sub-pixel. Films can be formed by any conventional deposition technique, including vapor deposition and liquid deposition. Typical liquid deposition techniques include, but are not limited to, continuous deposition techniques such as spin coating, gravure coating, curtain coating, dip coating, slot-die coating, spray coating, and continuous nozzle coating; and discontinuous deposition techniques such as ink jet printing, gravure printing, and screen printing.

In one embodiment, there are provided buffer layers deposited from aqueous dispersions comprising at least one conducive polymer and at least one colloid-forming polymeric acid, wherein the electrically conducting polymer is doped with at least one non-polymeric organic acid anion. In one embodiment, the buffer layers are deposited from aqueous dispersions comprising colloid-forming polymeric sulfonic acid. In one embodiment, the buffer layer is deposited from an aqueous dispersion comprising fluorinated polymeric acid colloids. In another embodiment, the fluorinated polymeric acid colloids are fluorinated polymeric sulfonic acid colloids. In still another embodiment, the buffer layer is deposited from an aqueous dispersion comprising at least one conductive polymer and perfluoroethylenesulfonic acid colloids, wherein the electrically conducting polymer is doped with at least one non-polymeric organic acid anion, and further wherein the conductive polymer is selected from poly(3,4-ethylenedioxythiophene), unsubstituted polypyrrole, and unsubstituted polyaniline.

In another embodiment, there are provided buffer layers deposited from aqueous dispersions comprising at least one conductive polymer doped with at least one non-polymeric acid anion, and at least one colloid-forming polymeric acid, which further comprise at least one co-dispersing liquid. In one embodiment, the co-dispersing liquid is selected from n-propanol, isopropanol, t-butanol, methanol dimethylacetamide, dimethylformamide, N-methylpyrrolidone, ethylene glycol, and mixtures thereof.

In one embodiment, the dried layers of the new composition are not redispersible or soluble in non-aqueous liquids, such as organic liquids. In one embodiment, the organic device comprising at least one layer comprising the new composition is made of multiple thin layers. In one embodiment, the layer can be further overcoated with a layer of different non-aqueous soluble or dispersible material without substantial damage to the layer's functionality or performance in an organic electronic device.

In another embodiment, there are provided buffer layers deposited from aqueous dispersions comprising at least one conductive polymer doped with least one non-polymeric acid anion, and at least one colloid-forming polymeric acid, which dispersion is further blended with other water soluble or dispersible materials. Depending on the final application of the material, examples of types of additional water soluble or dispersible materials which can be added include, but are not limited to polymers, dyes, coating aids, carbon nanotubes, metal nanowires and nanoparticles, organic and inorganic conductive inks and pastes, charge transport materials, piezoelectric, pyroelectric, or ferroelectric oxide nano-particles or polymers, photoconductive oxide nanoparticles or polymers, dispersing agents, crosslinking agents, and combinations thereof. The materials can be simple molecules or polymers. Examples of suitable other water soluble or dispersible polymers include, but are not limited to, polyacrylamide, polyvinylalcohol, poly(2-vinylpridine), poly(vinylacetate), poly(vinylmethylether), poly(vinylpyrrolidone), poly(vinylbutyral), poly(styrenesulfonic acid, and conductive polymers such as polythiophenes, polyanilines, polyamines, polypyrroles, polyacetylenes, and combinations thereof.

In another embodiment, there are provided electronic devices comprising at least one electrically conductive or semiconductive layer made from the new composition. Organic electronic devices that may benefit from having one or more layers made from the new composition include, but are not limited to, (1) devices that convert electrical energy into radiation (e.g., a light-emitting diode, light emitting diode display, or diode laser), (2) devices that detect signals through electronics processes (e.g., photodetectors, photoconductive cells, photoresistors, photoswitches, phototransistors, phototubes, IR detectors), (3) devices that convert radiation into electrical energy, (e.g., a photovoltaic device or solar cell), and (4) devices that include one or more electronic components that include one or more organic semi-conductor layers (e.g., a transistor or diode). Other uses for the new compositions include coating materials for memory storage devices, antistatic films, biosensors, electrochromic devices, solid electrolyte capacitors, energy storage devices such as a rechargeable battery, and electromagnetic shielding applications.

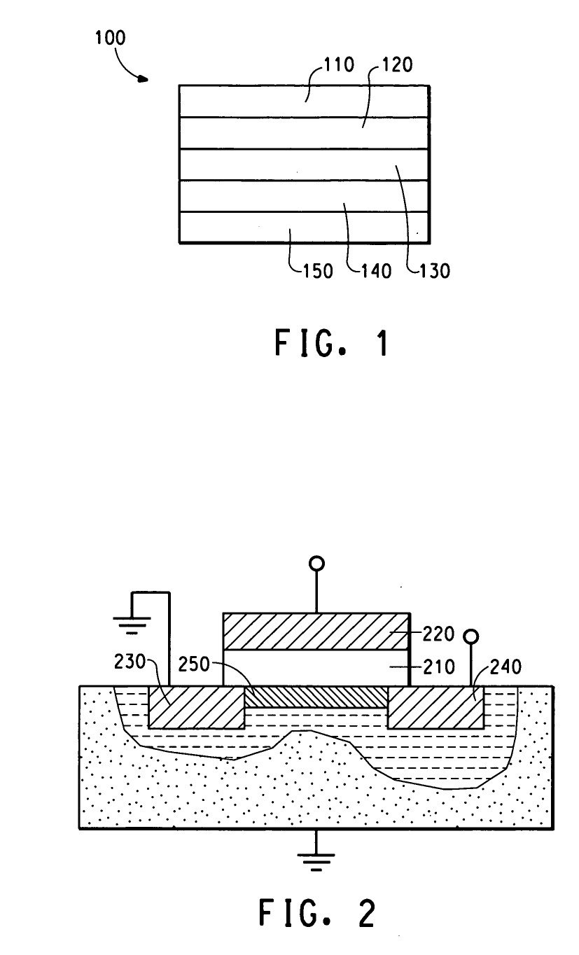

In one embodiment, the organic electronic device comprises an electroactive layer positioned between two electrical contact layers, wherein at least one of the layers of the device includes the new buffer layer. One embodiment is illustrated in one type of OLED device, as shown in FIG. 1, which is a device that has anode layer 110, a buffer layer 120, an electroluminescent layer 130, and a cathode layer 150. Adjacent to the cathode layer 150 is an optional electron-injection/transport layer 140. Between the buffer layer 120 and the cathode layer 150 (or optional electron injection/transport layer 140) is the electroluminescent layer 130.

The device may include a support or substrate (not shown) that can be adjacent to the anode layer 110 or the cathode layer 150. Most frequently, the support is adjacent the anode layer 110. The support can be flexible or rigid, organic or inorganic. Generally, glass or flexible organic films are used as a support. The anode layer 110 is an electrode that is more efficient for injecting holes compared to the cathode layer 150. The anode can include materials containing a metal, mixed metal, alloy, metal oxide or mixed oxide. Suitable materials include the mixed oxides of the Group 2 elements (i.e., Be, Mg, Ca, Sr, Ba, Ra), the Group 11 elements, the elements in Groups 4, 5, and 6, and the Group 8-10 transition elements. If the anode layer 110 is to be light transmitting, mixed oxides of Groups 12, 13 and 14 elements, such as indium-tin-oxide, may be used. As used herein, the phrase “mixed oxide” refers to oxides having two or more different cations selected from the Group 2 elements or the Groups 12, 13, or 14 elements. Some non-limiting, specific examples of materials for anode layer 110 include, but are not limited to, indium-tin-oxide (“ITO”), aluminum-tin-oxide, gold, silver, copper, and nickel. The anode may also comprise an organic material such as polyaniline, polythiophene, or polypyrrole. The IUPAC number system is used throughout, where the groups from the Periodic Table are numbered from left to right as 1-18 (CRC Handbook of Chemistry and Physics, 81^{st} Edition, 2000).

The anode layer 110 may be formed by a chemical or physical vapor deposition process or spin-coating process. Chemical vapor deposition may be performed as a plasma-enhanced chemical vapor deposition (“PECVD”) or metal organic chemical vapor deposition (“MOCVD”). Physical vapor deposition can include all forms of sputtering, including ion beam sputtering, as well as e-beam evaporation and resistance evaporation. Specific forms of physical vapor deposition include rf magnetron sputtering and inductively-coupled plasma physical vapor deposition (“IMP-PVD”). These deposition techniques are well known within the semiconductor fabrication arts.

The anode layer 110 may be patterned during a lithographic operation. The pattern may vary as desired. The layers can be formed in a pattern by, for example, positioning a patterned mask or resist on the first flexible composite barrier structure prior to applying the first electrical contact layer material. Alternatively, the layers can be applied as an overall layer (also called blanket deposit) and subsequently patterned using, for example, a patterned resist layer and wet chemical or dry etching techniques. Other processes for patterning that are well known in the art can also be used. When the electronic devices are located within an array, the anode layer 110 typically is formed into substantially parallel strips having lengths that extend in substantially the same direction.

The buffer layer 120 can be deposited onto substrates using any technique well-known to those skilled in the art.

The electroluminescent (EL) layer 130 may typically be any organic EL material, including, but not limited to, fluorescent dyes, fluorescent and phosphorescent metal complexes, conjugated polymers, and mixtures thereof. Examples of fluorescent dyes include, but are not limited to, pyrene, perylene, rubrene, derivatives thereof, and mixtures thereof. Examples of metal complexes include, but are not limited to, metal chelated oxinoid compounds, such as tris(8-hydroxyquinolato)aluminum (Alq3); cyclometalated iridium and platinum electroluminescent compounds, such as complexes of Iridium with phenylpyridine, phenylquinoline, or phenylpyrimidine ligands as disclosed in Petrov et al., Published PCT Application WO 02/02714, and organometallic complexes described in, for example, published applications U.S. 2001/0019782, EP 1191612, WO 02/15645, and EP 1191614; and mixtures thereof. Electroluminescent emissive layers comprising a charge carrying host material and a metal complex have been described by Thompson et al., in U.S. Pat. 6,303,238, and by Burrows and Thompson in published PCT applications WO 00/70655 and WO 01/41512. Examples of conjugated polymers include, but are not limited to poly(phenylenevinylenes), polyfluorenes, poly(spirobifluorenes), polythiophenes, poly(p-phenylenes), copolymers thereof, and mixtures thereof.

The particular material chosen may depend on the specific application, potentials used during operation, or other factors. The EL layer 130 containing the electroluminescent organic material can be applied using any number of techniques including vapor deposition, solution processing techniques or thermal transfer. In another embodiment, an EL polymer precursor can be applied and then converted to the polymer, typically by heat or other source of external energy (e.g., visible light or UV radiation).

Optional layer 140 can function both to facilitate electron injection/transport, and can also serve as a confinement layer to prevent quenching reactions at layer interfaces. More specifically, layer 140 may promote electron mobility and reduce the likelihood of a quenching reaction if layers 130 and 150 would otherwise be in direct contact. Examples of materials for optional layer 140 include, but are not limited to, metal-chelated oxinoid compounds (e.g., Alq₃ or the like); phenanthroline-based compounds (e.g., 2,9-dimethyl4,7-diphenyl-1,10-phenanthroline (“DDPA”), 4,7-diphenyl-1,10-phenanthroline (“DPA”), or the like); azole compounds (e.g., 2-(4-biphenylyl)-5-(4-t-butylphenyl)-1,3,4-oxadiazole (“PBD” or the like), 3-(4-biphenylyl)4-phenyl-5-(4-t-butylphenyl)-1,2,4-triazole (“TAZ” or the like); other similar compounds; or any one or more combinations thereof. Alternatively, optional layer 140 may be inorganic and comprise BaO, LiF, Li₂O, or the like.

The cathode layer 150 is an electrode that is particularly efficient for injecting electrons or negative charge carriers. The cathode layer 150 can be any metal or nonmetal having a lower work function than the first electrical contact layer (in this case, the anode layer 110). As used herein, the term “lower work function” is intended to mean a material having a work function no greater than about 4.4 eV. As used herein, “higher work function” is intended to mean a material having a work function of at least approximately 4.4 eV.

Materials for the cathode layer can be selected from alkali metals of Group 1 (e.g., Li, Na, K, Rb, Cs,), the Group 2 metals (e.g., Mg, Ca, Ba, or the like), the Group 12 metals, the lanthanides (e.g., Ce, Sm, Eu, or the like), and the actinides (e.g., Th, U, or the like). Materials such as aluminum, indium, yttrium, and combinations thereof, may also be used. Specific non-limiting examples of materials for the cathode layer 150 include, but are not limited to, barium, lithium, cerium, cesium, europium, rubidium, yttrium, magnesium, samarium, and alloys and combinations thereof.

The cathode layer 150 is usually formed by a chemical or physical vapor deposition process. In general, the cathode layer will be patterned, as discussed above in reference to the anode layer 110. If the device lies within an array, the cathode layer 150 may be patterned into substantially parallel strips, where the lengths of the cathode layer strips extend in substantially the same direction and substantially perpendicular to the lengths of the anode layer strips. Electronic elements called pixels are formed at the cross points (where an anode layer strip intersects a cathode layer strip when the array is seen from a plan or top view).

In other embodiments, additional layer(s) may be present within organic electronic devices. For example, a layer (not shown) between the buffer layer 120 and the EL layer 130 may facilitate positive charge transport, band-gap matching of the layers, function as a protective layer, or the like. Similarly, additional layers (not shown) between the EL layer 130 and the cathode layer 150 may facilitate negative charge transport, band-gap matching between the layers, function as a protective layer, or the like. Layers that are known in the art can be used. In addition, any of the above-described layers can be made of two or more layers. Alternatively, some or all of inorganic anode layer 110, the buffer layer 120, the EL layer 130, and cathode layer 150, may be surface treated to increase charge carrier transport efficiency. The choice of materials for each of the component layers may be determined by balancing the goals of providing a device with high device efficiency with the cost of manufacturing, manufacturing complexities, or potentially other factors.

The different layers may have any suitable thickness. In one embodiment, inorganic anode layer 110 is usually no greater than approximately 500 nm, for example, approximately 10-200 nm; buffer layer 120, is usually no greater than approximately 250 nm, for example, approximately 50-200 nm; EL layer 130, is usually no greater than approximately 100 nm, for example, approximately 50-80 nm; optional layer 140 is usually no greater than approximately 100 nm, for example, approximately 20-80 nm; and cathode layer 150 is usually no greater than approximately 100 nm, for example, approximately 1-50 nm. If the anode layer 110 or the cathode layer 150 needs to transmit at least some light, the thickness of such layer may not exceed approximately 100 nm.

In organic light emitting diodes (OLEDs), electrons and holes, injected from the cathode 150 and anode 110 layers, respectively, into the EL layer 130, form negative and positively charged polar ions in the polymer. These polar ions migrate under the influence of the applied electric field, forming a polar ion exciton with an oppositely charged species and subsequently undergoing radiative recombination. A sufficient potential difference between the anode and cathode, usually less than approximately 12 volts, and in many instances no greater than approximately 5 volts, may be applied to the device. The actual potential difference may depend on the use of the device in a larger electronic component. In many embodiments, the anode layer 110 is biased to a positive voltage and the cathode layer 150 is at substantially ground potential or zero volts during the operation of the electronic device. A battery or other power source(s) may be electrically connected to the electronic device as part of a circuit but is not illustrated in FIG. 1.

In one embodiment, OLEDs comprising at least one buffer layer deposited from the new composition have been found to have improved lifetimes. In one embodiment the buffer layer is deposited using any solution processing technique and is an aqueous dispersion in which the pH has been adjusted to above about 2.0.

In one embodiment a pH neutral composition is used in at least one layer of an electronic device. In one OLED embodiment, the pH is adjusted so as to reduce etching of the ITO layer during device fabrication and hence much lower concentration of In and Sn ions diffusing into the polymer layers of the OLED. Since In and Sn ions are suspected to contribute to reduced operating lifetime this is a significant benefit. The lower acidity also reduces corrosion of the metal components of the display (e.g. electrical contact pads) during fabrication and over the long-term storage. PEDT/PSSA residues will interact with residual moisture to release acid into the displays with resulting slow corrosion.

The layer in an organic electronic device comprising the new composition may further be overcoated with a layer of conductive polymer applied from a non-aqueous medium. The conductive polymer can facilitate charge transfer and also improve coatability. Examples of suitable conductive polymers include, but are not limited to, polyanilines, polythiophenes, polydioxythiophene/polystyrenesulfonic acid, polyaniline/polymeric-acid-colloids such as those disclosed in co-pending application Ser. No.10/669577, polythiophene/polymeric-acid-colloids such as those disclosed in co-pending application Ser. No. 10/669494, polypyrroles, polyacetylenes, and combinations thereof. The composition comprising such a layer may further comprise conductive polymers, and may also comprise dyes, carbon nanotubes, carbon nanoparticles, metal nanowires, metal nanoparticles, carbon fibers and particles, graphite fibers and particles, coating aids, organic and inorganic conductive inks and pastes, charge transport materials, semiconductive or insulating inorganic oxide particles, piezoelectric, pyroelectric, or ferroelectric oxide nanoparticles or polymers, photoconductive oxide nanoparticles or polymers, dispersing agents, crosslinking agents and combinations thereof. These materials can be added to the new composition either before or after polymerization of the monomer and/or before or after treatment with at least one ion exchange resin.

In one embodiment, there are provided thin film field effect transistors comprising electrodes made from the new composition. For use as electrodes in thin film field effect transistors, the conducting polymers and the liquids for dispersing or dissolving the conducting polymers must be compatible with the semiconducting polymers and the solvents for the semiconducting polymers to avoid re-dissolution of either conducting polymers or semiconducting polymers. Thin film field effect transistor electrodes fabricated from conducting polymers should have a conductivity greater than 10 S/cm. However, electrically conducting polymers doped with non-polymeric organic acid anions only provide conductivity in the range of 10 S/cm or lower. Thus, in one embodiment, the electrodes comprise a conductive polymer selected from polythiophenes, polypyrroles, and polyanilines doped with at least one non-polymeric organic acid anion, and a fluorinated colloid-forming polymeric sulfonic acid in combination with electrical conductivity enhancers such as metal nanowires, metal nanoparticles, carbon nanotubes, or the like. The new compositions may be used in thin film field effect transistors as gate electrodes, drain electrodes, or source electrodes.

Another illustration of a use for the new composition, is the thin film field effect transistors, is shown in FIG. 2. In this illustration, a dielectric polymer or dielectric oxide thin film 210 has a gate electrode 220 on one side and drain and source electrodes, 230 and 240, respectively, on the other side. Between the drain and source electrode, an organic semiconducting film 250 is deposited. New aqueous dispersions containing nanowires or carbon nanotubes are ideal for the applications of gate, drain and source electrodes because of their compatibility with organic based dielectric polymers and semiconducting polymers in solution thin film deposition. Since new compositions as a colloidal dispersion, less weight percentage of the conductive fillers is required (relative to compositions containing water soluble polymeric sulfonic acids) to reach percolation threshold for a desired or high electrical conductivity.

In another embodiment, there are provided field effect resistance devices comprising one layer comprising the new composition. The field effect resistance devices undergo reversible change of resistance in the conducting polymer films when subjected to a pulse of gate voltage as illustrated in pages 339-343, No. 2, 2002, Current Applied Physics.

In another embodiment, there are provided electrochromic displays comprising at least one layer comprising the new composition. Electrochromic displays utilize change of color when thin film of the material is subjected to electrical potential. In one embodiment, the new composition is superior for this application because of the high pH of the dispersion.

In yet another embodiment, there are provided memory storage devices comprising silicon chips top-coated with the new composition. For example, a write-once-read-many-times (WORM) memory is known in the arts (Nature, Page 166 to 169, vol 426, 2003). When information is recorded, higher voltages at certain points in the circuit grids of silicon chips destroys the conductive polymer at those points to create “zero” bit data. The conductive polymer at the untouched points remains electrically conductive and becomes “1” bit data.

In another embodiment, the new compositions are used to form coatings for biosensor or electromagnetic shielding applications.

In another embodiment, the new compositions can be used for antistatic coatings for plastic and cathode ray tubes, electrode materials for solid electrolyte capacitors, metal anti-corrosion coatings, through-hole plating of printed circuit boards, photodiodes, bio-sensors, photodetectors, rechargeable batteries, photovoltaic devices, and photodiodes. In addition, examples of other applications for the new compositions can be found in, for example, Advanced Materials, page 490 to 491, vol. 12, No. 7, 2000.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The new compositions and its uses will now be described in greater detail by reference to the following non-limiting examples.

### EXAMPLES

### Comparative Example 1

This comparative example illustrates device performance using a commercial aqueous polypyrrole composition.

A commercial aqueous polypyrrole composition (5%, w/w) from Aldrich (2003-2004 Cat # 48,255-2) is a conductive polypyrrole doped with a proprietary non-polymeric organic acid. This was diluted with deionized water down to 2.5% w/w, and stirred for 15 minutes. The dilution was necessary to obtain a viscosity which allowed the use of reasonable spin rates (<5,000 RPM). The diluted composition had a pH of 1.7 and conductivity of 3.5×10⁻³ S/cm. The composition was then checked for particle size using an AccuSizer Model 780A (Particle Sizing Systems, Santa Barbara, Calif.). Particle size count (“PSC”) was 135,705 particles in one mL with particles greater than 0.75 μm. The data clearly shows that the conductive polypyrrole composition is a dispersion in water. A portion of this diluted polypyrrole dispersion was used for device fabrication and testing. The other portion was used in Examples 1 and 3.

The diluted polypyrrole dispersion was used to spin on to glass/ITO substrates (30 mm×30 mm) having an ITO thickness of 100 to 150 nm, and baked at 200° C. in air for 5 minutes. The substrates had a 15 mm×20 mm ITO area for light emission. The thickness of the buffer layer is given in Table 1 below. For the light-emitting layer, a 1% (w/v) toluene solution of Lumination Green from Dow Chemicals (Midland, Mich.) was spin-coated on top of the buffer layerfilms to a thickness of ˜700 Å, and subsequently baked at 180° C. in a dry box for 10 minutes. Immediately after, a 3 nm thick barium layer and a 300-500 nm aluminum layer were deposited on the Lumination Green films to serve as a cathode. The device data is summarized in Table 1.

### Example 1

This example illustrates the blending of Nafion® with the diluted aqueous polypyrrole dispersion made in Comparative Example 1 by sonication, and the performance of devices made therewith.

The Nafion® used for the blending is a 12.3% (w/w) aqueous colloidal dispersion of perfluoroethylenesulfonic acid having an EW of 1050. A 25% (w/w) Nafion® was made first using a procedure similar to the procedure in U.S. Pat. No. 6,150,426, Example 1, Part 2, except that the temperature was approximately 270° C. The Nafion® dispersion was diluted with water to form a 12.3 % (w/w) dispersion for the use of this invention.

18.09 g Nafion® was slowly dripped into a 250 mL round bottom flask containing 81.99 g of the diluted polypyrrole dispersion prepared in Comparative Example 1, while being stirred with a magnetic stirrer. It took about one and one-half hours to complete the addition. The mixture was left stirred overnight and was then transferred to a 250 mL plastic bottle. The resulting dispersion contains 4.22% solid in which the weight ratio of Nafion® to polypyrrole+non-polymeric acid anion is 1.1 to 1.0. The entire dispersion was then subjected to sonication using an Ultrasonic Processor XL (Heat Systems, Inc., Farmingdale, N.Y., USA) set at power 7 for total 30 seconds “On” time (15 seconds On/ 15 seconds Off). It was sonicated one more time using the same conditions. The dispersion was then checked for particle size using an AccuSizer Model 780A (Particle Sizing Systems, Santa Barbara, Calif.). Particle size count (“PSC”) was 411,438 particles in one mL of dispersion with particles greater than 0.75 μm. The dispersion has a pH of 1.5 and conductivity of 2.1×10⁻³S/cm. Device fabrication was made using the same procedure as in Comparative Example 1. The data is summarized in Table 1, which shows a lower voltage (3.5V vs. 3.9V) and a much higher efficiency (9.2 cd/A vs. 1.2 cd/A) than in Comparative Example 1.

### Example 2

This example illustrates the effect of pH on the sample made in Example 1.

To a portion of the sample made in Example 1, which has a pH of 1.5, was added a 1.0M aqueous NaOH solution, to achieve a pH of 3.8. After adjustment to a high pH, film conductivity of the dispersion is 9.4×10⁻⁵ S/cm. Particle size count (“PSC”) was 8,418,154 particles in one mL of dispersion with particles greater than 0.75 μm. Device fabrication was made using the same procedure as in Comparative Example 1. The data is summarized in Table 1, which shows that the device made with the dispersion with high pH (3.8) has a lower efficiency (6.5 cd/A vs. 9.8 cd/A) and higher voltage (3.8 volt vs. 3.5 volt) when compared with the device made in Example 1, which has a pH of 1.5.

### Example 3

This example illustrates the blending of a higher concentration of Nafion® with the diluted aqueous polypyrrole dispersion made in Comparative Example 1 by sonication, and the performance of devices made therewith.

30.57 g Nafion® made and diluted as in Example 1 was slowly dripped into a 250 mL round bottom flask containing 69.47 g of the diluted polypyrrole dispersion prepared in Comparative Example 1 while being stirred with a magnetic stirrer. It also took about one and one-half hours to complete the addition. The mixture was left stirred overnight and was then transferred to a 250 mL plastic bottle. The resulting dispersion contained 5.4% solid in which the weight ratio of Nafion® to polypyrrole+non-polymeric acid anion is 2.11 to 1.0. The entire dispersion was then subjected to sonication using an Ultrasonic Processor XL (Heat Systems, Inc., Farmingdale, N.Y., USA) set at power 7 for total 30 seconds “On” time (15 seconds On/ 15 seconds Off). It was sonicated one more time using the same conditions. The particle size count (“PSC”) was 453,957 particles in one mL of dispersion with particles greater than 0.75 μm. The dispersion has a pH of 1.5 and conductivity of 4.9×10⁻⁴ S/cm. Device fabrication was made using the same procedure as in Comparative Example 1. The data is summarized in Table 1, which also shows a lower voltage (3.4V vs. 3.9V) and a much higher efficiency (10.2 cd/A vs. 1.2 cd/A).

### Example 4

This example illustrates the effect of pH on the sample made in Example 3.

To a portion of the sample made in Example 3, which has a pH of 1.5 was added a 1.0M aqueous NaOH solution to achieve a pH of 3.7. After adjustment to a high pH, film conductivity of the dispersion is 1.1×10⁻⁴ S/cm. The particle size count (“PSC”) was 8,338,242 particles in one mL of dispersion with particles greater than 0.75 μm. Device fabrication was made in the same procedure as in Comparative Example 1. The data is summarized in Table 1, which shows that the device made with the dispersion having the high pH has a much higher efficiency (12.6 cd/A vs. 10.2 cd/A) compared with the device made in Example 3, which has a pH of 1.5. A comparison of Examples 2 and 4 shows that the weight ratio of Nafion® to polypyrrole/acid anion should be greater than 1.1 to 1.0 in order to achieve improved device performance at higher pH levels.

TABLE 1
Device performance at 1,000 cd/m2 and 25° C.

| | Com. Ex. 1 | Ex. 1 | Ex. 2 | Ex. 3 | Ex. 4 |
|---|---|---|---|---|---|
| Buffer | pH = 1.7 | pH = 1.5 | pH = 3.8 | pH = 1.5 | pH = 3.7 |
| Efficiency | 1.2 | 9.2 | 6.5 | 10.2 | 12.6 |
| (cd/A) | | | | | |
| Voltage | 3.9 | 3.5 | 3.8 | 3.4 | 3.7 |
| (V) | | | | | |
| Buffer | 747 | 761 | 551 | 761 | 668 |
| Thickness | | | | | |
| (Å) | | | | | |
| Conduc- | 3.5 × 10⁻³ | 2.1 × 10⁻³ | 9.4 × 10⁻⁵ | 4.9 × 10⁻⁴ | 1.1 × 10⁻⁴ |
| tivity | | | | | |
| (S/cm) | | | | | |

### Example 5

This example illustrates the dispersibility of the PPy blended with Nafion® prepared in Example 4 and applications.

A few drops of the aqueous dispersion were spread on each of two microscope slides for drying at room temperature in an inert atmosphere. The dried solid film was readily re-dispersible in water as soon as it was immersed in water. However, it remained intact when it was immersed in dimethylacetamide (DMAc) or 1-methyl-2-pyrrolidinone (NMP). The non-redispersibility will allow additional layer deposition of organic materials such as charge transporting materials, or surface wetability promoter materials which are soluble in DMAc and NMP.

1. A composition comprising an aqueous dispersion of at least one conductive polymer and at least one colloid-forming polymeric acid, wherein the electrically conducting polymer is doped with at least one non-polymeric organic acid anion, and wherein the conductive polymer is selected from a polythiophene, a polypyrrole, a polyaniline, and combinations thereof.

2. A composition according to claim 1, wherein pH of the dispersion is between 1 and 8.

3. A composition according to claim 1, wherein the polythiophene comprises Formula I: 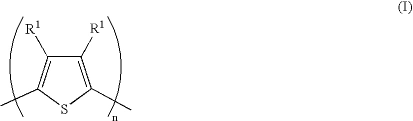
wherein:
R¹ is independently selected so as to be the same or different at each occurrence and is selected from hydrogen, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, alcohol, benzyl, carboxylate, ether, ether carboxylate, amidosulfonate, ether sulfonate, and urethane; or both R¹ groups together may form an alkylene or alkenylene chain completing a 3, 4, 5, 6, or 7-membered aromatic or alicyclic ring, which ring may optionally include one or more divalent nitrogen, sulfur or oxygen atoms, and n is at least about 4.

4. A composition according to claim 1, wherein the polypyrrole comprises Formula II: 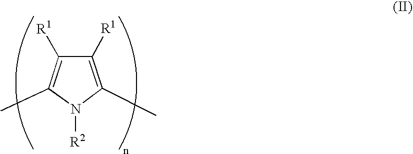
wherein:
n is at least about 4;
R¹ is independently selected so as to be the same or different at each occurrence and is selected from hydrogen, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, alcohol, benzyl, carboxylate, ether, ether carboxylate, amidosulfonate, ether sulfonate, and urethane; or both R¹ groups together may form an alkylene or alkenylene chain completing a 3, 4, 5, 6, or 7-membered aromatic or alicyclic ring, which ring may optionally include one or more divalent nitrogen, sulfur or oxygen atoms; and
R² is independently selected so as to be the same or different at each occurrence and is selected from hydrogen, alkyl, alkenyl, aryl, alkanoyl, alkylthioalkyl, alkylaryl, arylalkyl, amino, epoxy, silane, siloxane, alcohol, benzyl, carboxylate, ether, ether carboxylate, amidosulfonate, ether sulfonate, and urethane.

5. A composition according to claim 1, wherein the polyaniline comprises Formula III or Formula IV: 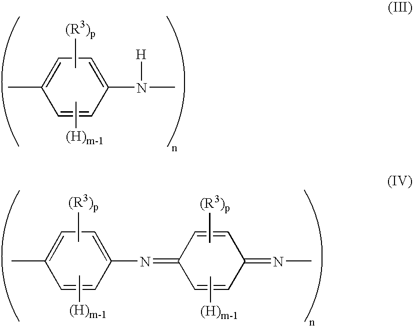
wherein:
n is at least about 4;
p is an integer from 0 to 4;
m is an integer from 1 to 5, with the proviso that p+m=5; and
R³ is independently selected so as to be the same or different at each occurrence and is selected from alkyl, alkenyl, alkoxy, cycloalkyl, cycloalkenyl, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen, cyano, or alkyl substituted with one or more of sulfonic acid, carboxylic acid, halo, nitro, cyano or epoxy moieties; or any two R³ groups together may form an alkylene or alkenylene chain completing a 3, 4, 5, 6, or 7-membered aromatic or alicyclic ring, which ring may optionally include one or more divalent nitrogen, sulfur or oxygen atoms.

6. A composition according to claim 1, wherein the non-polymeric polymeric organic acid anion is selected from acetate, p-toluenesulfonate, camphorsulfonate, p-dodecylbenzenesulfonate, methanesulfonate, trifluoromethanesulfonate, and mixtures thereof.

7. A composition according to claim 1, wherein said colloid-forming polymeric acid is selected from polymeric sulfonic acids, polymeric phosphoric acids, polymeric phosphonic acids, polymeric carboxylic acids, polymeric acrylic acids, and mixtures thereof.

8. A composition according to claim 7, wherein said colloid-forming polymeric acid comprises a fluorinated polymeric sulfonic acid.

9. A composition according to claim 8, wherein said polymeric sulfonic acid is perfluorinated.

10. A composition according to claim 1, further comprising an additional material selected from polymers, dyes, carbon nanotubes, metal nanowires, metal nanoparticles, carbon nanoparticles, carbon fibers, carbon particles, graphite fibers, graphite particles, coating aids, organic and inorganic conductive inks and pastes, charge transport materials, semiconductive or insulating inorganic oxide nano-particles, piezoelectric, pyroelectric, or ferroelectric oxide nano-particles or polymers, photoconductive oxide nanoparticles or polymers, dispersing agents, crosslinking agents, and combinations thereof.

11. A composition according to claim 1, further comprising at least one co-dispersing liquid.

12. A composition according to claim 11, wherein the co-dispersing liquid is selected from ethers, cyclic ethers, alcohols, alcohol ethers, ketones, nitriles, sulfides, sulfoxides, amides, amines, carboxylic acids, and combinations thereof.

13. An electrically conductive or semiconductive layer deposited from a composition according to claim 1.

14. A buffer layer deposited from a composition according to claim 1.

15. A buffer layer according to claim 14 wherein said colloid-forming polymeric acid is perfluoroethylenesulfonic acid.

16. A buffer layer made from an aqueous dispersion comprising electrically conductive polypyrrole/non-polymeric acid dopant and polymeric perfluroethylenesulfonic acid, wherein the aqueous dispersion has a pH greater than 2 and a weight ratio of polymeric perfluroethylenesulfonic acid to polypyrrole+non-polymeric acid anion greater than 1.

17. An electronic device or other applications comprising at least one layer comprising at least one composition of claim 1.

18. A device according to claim 17, wherein the device or application is selected from devices that convert electrical energy into radiation, devices that detect signals through electronics processes, that convert radiation into electrical energy, devices having at least one electronic component, memory storage devices, energy storage devices, antistatic films, biosensor devices, electrochromic devices, and electromagnetic shielding applications.

19. A method of making the composition of claim 1, the method comprising one of the following:
(a) dispersing doped conductive polymer solids in an aqueous dispersion of colloid-forming polymeric acid;
(b) dispersing colloid-forming polymeric acid solids in an aqueous dispersion of doped conductive polymer; and
(c) combining the dispersion of doped conductive polymer with an aqueous dispersion of colloid-forming polymeric acid.
